(19) United States
(12) Patent Application Publication
(10) Pub. No.: US 2010/0093924 A1
(43) Pub. Date: Apr. 15, 2010

(54) Modified Poly(meth)acrylate with Reactive Ethylenic Groups and Use Thereof

(76) Inventors: Andreas Lerschmacher, Dusseldorf (DE); Siegfried Krause, Ascheberg (DE); Peter Kuhlmann, Wulfrath (DE); Klaus Hock, Regen (DE)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 11/883,403

(22) PCT Filed: Jan. 11, 2006
(86) PCT No.: PCT/EP2006/000188

§ 371 Date: Dec. 15, 2009

(30) Foreign Application Priority Data
Feb. 1, 2005 (DE) 10 2005 004 639.8

(51) Int. Cl. C08L 75/00; C08F 220/10

(52) U.S. Cl. 524/589; 525/126

(57) ABSTRACT

The invention relates to a synthetic resin, based on partly cross-linked poly(meth)acrylate-urethane-(meth)acrylates in urethane(meth)acrylates, obtainable by: (a) provision of (meth)acrylate monomers (I), which have no groups reactive to isocyanate groups and (meth)acrylate monomers (II), with (a) group(s) reactive to isocyanate groups, (b) polymerization of the (meth)acrylate monomers (I) and (II) to give a poly(meth)acrylate (III), with groups reactive to isocyanate groups, (c) reaction of the poly(meth)acrylate (III) with an isocyanate compound (IV), with more than one isocyanate group, in such a manner that 5 to 40% of the isocyanate groups of the isocyanate compound (IV) react with the above groups reactive to isocyanate groups, whereby partial cross-linking of (III) with an increase in weight average molecular weight by a factor of 2 to 20 occurs, in which one given (IV) reacts with more than one of the isocyanate groups thereof with more than one given (III) and (d) reaction of the compound obtained in (c) with (meth)acrylate monomers (II). The synthetic resin can be used as a binder, for example, in a radical-hardenable composition, suitable for application in the production of composite materials, composite workpieces, and paints with advantageous physical and chemical properties.

The invention relates to synthetic resins based on poly(meth)acrylate-urethane-(meth)acrylates in urethane(meth)acrylates and optionally (meth)acrylates and/or reactive diluents as well as the production thereof. Due to the reactive ethylenic groups, in particular in the side chains of the poly(meth)acrylate-urethane-(meth)acrylates, the synthetic resins of the present invention are radical hardenable and can be used as binders for mixtures of substances. The invention also relates to the composite materials and workpieces obtained from these mixtures, as well as to the production and use of these binders, composite materials and workpieces themselves. Furthermore, the synthetic resins of the present invention can also be used in the production of paints.

Composites are materials which are obtained by combining different materials and whose chemical and physical properties surpass those of the individual components.

They are used e.g. in civil engineering, in technology (in the automotive industry, in aviation and space technology, in electrical engineering and electronics, in mechanical and tool engineering, etc.) and in the medical field.

The most common production process for composite materials is the mechanical-thermal combination of one or more insertion materials with a matrix. An alternative to the mechanical-thermal combination is to prepare the components of the composite from a homogenous starting material by means of phase separation. According to present day state of the art, only the mechanical-thermal combination process is suitable for the production of large components and for mass production at low costs. The phase separation process is suitable for the production of small components subjected to very high loads, for which the production costs do not matter as much.

Components of composites include e.g. metals, wood, glasses, polymers and ceramic materials which can be processed into fiber, band, layer and particle composites.

The most significant type of for example fiber-reinforced plastics, in turn, is glass-fiber reinforced plastics (GFP). Basically, it is an essential advantage of fiber-reinforced plastics that due to their partly excellent mechanical properties they can be used instead of metals which leads to considerable savings in terms of weight.

Polymer concrete, a typical particle composite material, is another example of a composite material wherein synthetic resins, which could basically be replaced with the synthetic resins of the present invention, serve as a matrix. For instance, in order to improve the processing and/or handling properties, the hydraulic binder in polymer concrete is partially or completely replaced with concrete additives on the basis of synthetic resins, in particular reactive resins (RH concrete).

The important aspect in all these composite materials with a matrix based on synthetic resins is the bond between the matrix resin and the various fillers.

In the case of inorganic fillers, the bond is often an indirect bond via adhesion promoters; thus, inorganic fillers are e.g. often silanized.

Between organic fillers and the matrix resin, a direct bond is formed via physical-chemical bonding, chemical bonding or adhesion.

A direct bond via physical-chemical bonding can for example be formed when a polymeric filler is solubilized by the matrix monomer. This solubilization, which is referred to as partial swelling, takes place in casting resins on the basis of methylmethacrylate (MMA)/polymethylmethacrylate (PMMA). These are systems which usually comprise at least two components, a liquid, the MMA with additives, and a powder, the PMMA with additives.

When the methylmethacrylate component is mixed with the polymethylmethacrylate component, the liquid solubilizes the powder and a dough is obtained which, depending on the particle-size distribution and the molar mass of the PMMA beads, more or less quickly turns into a paste or a highly viscous solution. This solubilization process is interrupted at the start of a polymerization reaction. The new thread molecules formed from the MMA during this process permeate the PMMA powder particles added as filler and become intimately entangled with their thread molecules so that at first physical anchoring occurs. However, hydrogen bridge bonds can be formed as well, and/or—even only to a rather limited extent—chain-transfer reactions can take place, i.e. there is a possibility of an additional chemical bonding. This type of bond could possibly even be considered a partially interpenetrating network.

Basically, a direct bond via chemical bonding is formed when the matrix monomer can react with the filler polymer in a grafting reaction. Such grafting reactions are possible if the filler polymer for example comprises unsaturated double bonds or other reactive functional groups, for example hydroperoxide, amino or carboxy groups, on its surface.

Such direct bonds via physical-chemical and in particular chemical bonding are extremely strong and durable.

The problem observed during the radical hardening of casting resins on the basis of MMA/PMMA is the exothermic reaction. During this reaction, a part of the methylmethacrylate evaporates, which leads to bubbles, cracks and emissions.

Furthermore, the reaction of the monomers to form polymers always involves a more or less extensive reduction in volume, also referred to as shrinkage or contraction. This is due to the fact that the larger intermolecular distances between the monomer building blocks are replaced with the much shorter distances of the covalent bonds in the polymer chains. Moreover, during hardening both the entropy and the free volume are reduced. Basically, it can be stated that as the molecular weight of the monomers and the spatial requirements of the side chains increase and the content of reactive groups per monomer decreases, the reduction in volume decreases.

In the production of workpieces such as plates (e.g. work surfaces) or also molded parts (e.g. sinks), wherein a mixture of substances consisting of 10 to 50 wt.-% monomeric methacrylates such as MMA (which optionally additionally comprise polymers such as PMMA dissolved therein), 50 to 90 wt.-% coated fillers and various other ingredients, is processed in a reaction casting process, the shrinkage upon hardening for the entire system is of course also reduced as the filling degree increases since the solid particles remain unchanged in terms of their volume during the reaction.

For such workpieces, efforts are often made during hardening to obtain an accumulation of filler materials at the surface in order to render it more scratch-resistant and thermally stable, and often also to produce optical effects. When such surfaces are polished in order to obtain reflecting surfaces, the filler materials at the surface turn at temperatures above the glass transition temperature of the respective polymethacrylate in order to relieve the stress generated during hardening, and an imperfect surface—with respect to the mirror effect—is obtained.

Although composites on the basis of polymethacrylate, due to various resistance properties (UV and/or chemical resistance) already stand out positively against other composites, further increase in thermal stability and chemical resistance, optical improvement (gloss, brilliance, depth of color), as well as a reduction in the number and size of bubbles and cracks, and a decrease in emissions and shrinkage—all while maintaining the existing advantages of the various composites—is desirable.

Taking into account the above statements, the use of a synthetic resin comprising a radical hardenable and thus cross-linking (meth)acrylate resin instead of the optionally present polymer, in combination with a simultaneous partial to complete replacement of the monomeric (meth)acrylate, suggests itself for this purpose.

Examples of such resins, which as unsaturated compound with reactive groups lead to film formation via free radicals in cross-linking reactions, include, inter alia, acrylated polyester, acrylated urethanes, acrylated polyacrylates, acrylated epoxy resins, oligoether acrylates as well as unsaturated polyester/styrene binders.

Urethane(meth)acrylates are used especially for the overcoating of PVC and cork flooring because of their high degree of abrasion resistance and flexibility. Other fields of application include wood coatings, overprint varnishes, printing inks and leather coatings. Furthermore, urethane(meth)acrylates are used in coating systems for flexible plastic substrates. In the electrical industry, urethane(meth)acrylates are used in silk-screen inks and solder resists for printed circuit boards.

There are several representatives of urethane(meth)acrylate compounds which can be prepared from a multitude of starting materials.

On principle, (meth)acrylated urethanes are obtained from the reaction of an isocyanate group with a hydroxyl group-containing acrylate or methacrylate monomer. When diisocyanates are used, the corresponding divinyl products are obtained.

The simplest urethane(meth)acrylates are formed in the reaction of a diisocyanate with a hydroxyl group-containing acrylate or methacrylate monomer. When additional hydroxyl group-containing compounds are used, for example polyols, polyester or polyether with more than one hydroxyl group, a chain extension takes place.

A multitude of urethane(meth)acrylates can be prepared by using starting materials with several hydroxyl groups. Flexible urethane(meth)acrylates are e.g. formed in the reaction of a diisocyanate with a long-chain diol and a hydroxyl group-containing monomer. A more or less hard urethane(meth)acrylate is formed in the reaction of a diisocyanate with a more or less highly branched multifunctional polyol and a hydroxyl group-containing monomer.

There are basically two methods of preparation. On the one hand, it is possible to react a hydroxyl group-containing precondensate or addition polymer with an excess of diisocyanate. The unsaturated urethane(meth)acrylate is then formed by way of hydroxyalkyl(meth)acrylate addition. Alternatively, the diisocyanate and hydroxyalkyl(meth)acrylate may be reacted first, after which the semiadduct is reacted with a hydroxyl group-containing polycondensate or addition polymer.

The three main classes of urethane(meth)acrylates are polyesterurethane(meth)acrylates, polyetherurethane(meth)acrylates and polyolurethane(meth)acrylates.

Urethane(meth)acrylate compounds having very different properties are available commercially. Modifications to the polymer framework, for example in terms of chain length, concentration of reactive groups and other functional parameters, influence the properties of the products in different respects.

Recent developments in the field of urethane(meth)acrylates include the preparation thereof on the basis of difunctional α,ω-polymethacrylate diols (cf. EP 1 132 414). The poly(meth)acrylate-urethane-(meth)acrylates of the present invention differ from those in a usually higher molecular weight, the special preparation process which in the end makes it possible that these (meth)acrylate—if desired—are exclusively present in reactive solvents, as well as the polyfunctional character; they do not only comprise terminal functional groups.

European patent application EP 1 306 399 describes a photocurable primer composition comprising an acyl resin which contains in its side chain, through urethane linkage, a polymerizable unsaturated group, as well as a urethane(meth)acrylate oligomer containing at least one polymerizable unsaturated group per molecule. The primer composition is prepared by reacting a hydroxyl group-containing acyl resin and a compound containing isocyanate groups and polymerizable unsaturated groups, or alternatively by reacting an acyl resin containing isocyanate groups and a compound containing hydroxyl groups and polymerizable unsaturated groups.

Acrylo-acrylates, which share the principle of the “poly(meth)acrylate backbone” as well as the functional groups with the poly(meth)acrylate-urethane-(meth)acrylates of the present invention, can be obtained by a radical-initiated polymerization of suitable functional and non-functional monomers in indifferent organic solvents. Unreacted peroxide is destroyed by keeping the reaction mixture at the reaction temperature for several hours. Then a suitably functional acrylate monomer and/or oligomer is added and reacted in the temperature range T_{R}=50 to 120° C.

It is the object of the present invention to provide synthetic resins suitable for formulating radical hardenable mixtures of substances to be used in the production of composite materials and corresponding workpieces, as well as the mixtures of substances, composite materials and workpieces themselves. It is another object of the present invention to provide synthetic resins suitable for formulating radical hardenable mixtures of substances to be used in the production of paints, as well as the paints themselves.

The corresponding composite materials and workpieces should stand out positively against those already on the market in terms of their properties. The bond plastic should therefore always be (meth)acrylate-based, for example, composite materials and workpieces on the basis of phenol, polyester or epoxy resins are, inter alia, not UV-resistant, not color-fast, and/or show no gloss and transparency. Thus, if desired, the new system should provide high-quality, optically sophisticated surfaces so that no finishing paint is required. The possible applications are numerous, possible workpieces include for example pot handles, switches for electrical devices, shell seats, wind turbine blades, decorative surfaces, garden tiles, benches or also work surfaces and sinks.

Compared to known materials, the materials of the present invention should be characterized in that
they do not show any or fewer and smaller bubbles and cracks,
they exhibit a higher thermal stability and chemical resistance,
there is no or less shrinkage and emissions during their production,
they can be produced more quickly,
they exhibit improved optical features,
   while positive properties such as
impact strength,
UV-resistance,
hydrophobicity, oleophobicity.
   are maintained.

Furthermore, the hardenable composition used in the production of the materials and workpieces of the present invention should be characterized by improved flow behavior and thus in the end also in that the fillers contained therein are wetted better.

In the case the radical hardenable composition is used to produce a composite material, a composite workpiece, paint or a comparable coating, solvents and other volatile components entrapped in the finished product often pose a problem during hardening. This is particularly true when comparatively quick hardening processes such as UV hardening are used. For example, a reduction in the hardness and scratch resistance may occur, bubbles and cavities may be formed, chemical resistance may be compromised, and the use of such composite workpieces, or of objects coated with such a paint, may entail undesired side effects such as unpleasant odors or even adverse health effects. Gradual outgassing of volatile components from workpieces or painted surfaces, followed by condensation phenomena and aggregation with dust particles can also lead to the formation of an often oily or sticky film on surfaces in the vicinity of the painted part which leads to graying, e.g. on windshields in new cars or room surfaces in new or renovated apartments. This effect is also referred to as “fogging”. Thus, a formulation which does not entail these disadvantages but at the same time offers the advantages described above would be desirable.

These objects in particular, as well as the preparation of a novel, radical hardenable system, which can generally be used for the preparation of composite materials and workpieces or paints with improved properties, are achieved by the subject-matter of the present invention.

It has surprisingly been found that by using the claimed synthetic resins of the present invention, which will be described in more detail below, excellent radical hardenable compositions can be provided. These compositions can optionally be formulated in combination with additives to form radical hardenable masses, from which composite materials and workpieces as well as paints can be produced which meet the requirements described above.

Thus, the composite materials, workpieces and paints prepared according to the present invention stand out against those known from the prior art and described above in particular with respect to their thermal stability and chemical resistance. Furthermore, in contrast with the prior art, the composite materials and workpieces of the present invention do not exhibit any cracks or bubbles and show a markedly lower degree of shrinkage. Also, an increased depth of color and brilliance can be observed in the composite materials and workpieces, as well as a thixotropic flow behavior of the various hardenable compositions. In the end, these properties can be attributed to a better wetting of the additives, in particular the fillers, due to the additional structural subunits (urethane groups) in the poly(meth)acrylate-urethane-(meth)acrylates and urethane(meth)acrylates prepared according to the present invention. According to the present invention, coating the additives, in particular the fillers, with adhesion promoters can be foregone, as can the addition of rheological additives. Thus, the synthetic resins prepared according to the present invention are usually present as a viscous solution or, in the case of stronger intermolecular interactions, as a wax-like mass.

It is another specific feature of the present invention that compared to the prior art, the hardening time as well as the energy required for hardening can be reduced. This is in particular due to the fact that the synthetic resins of the present invention comprise quite a substantial content of higher-molecular multifunctional poly(meth)acrylates. Due to this content of higher-molecular, and in particular partially crosslinked—which will be demonstrated below—less stress occurs during a final hardening which otherwise can negatively affect the quality of a workpiece thus produced.

Aliphatic structures in the poly(meth)acrylate-urethane-(meth)acrylates and the urethane(meth)acrylates impart additional hydrophobicity to the resin system and thus contribute to a high degree of chemical resistance.

The UV-resistance of the hardened resin system of the present invention is also remarkable. For instance, in a preferred embodiment, the components contained in the synthetic resins of the present invention are completely free of aromatic structures or other structures unstable under UV light.

Thus, in one embodiment, the invention is directed to a synthetic resin based on poly(meth)acrylate-urethane-(meth)acrylates in urethane(meth)acrylates obtainable by:

(a) provision of (meth)acrylate monomers (I), which have no groups reactive to isocyanate groups and (meth)acrylate monomers (II), with (a) group(s) reactive to isocyanate groups;

(b) polymerization of the (meth)acrylate monomers (I) and (II) to give a poly(meth)acrylate (III), with groups reactive to isocyanate groups;

(c) reaction of the poly(meth)acrylate (III) with an isocyanate compound (IV), with more than one isocyanate group, in such a manner that 5 to 40% preferably 10 to 30%, of the isocyanate groups of the isocyanate compound (IV) react with the above groups reactive to isocyanate groups, whereby partial cross-linking of (III) with an increase in weight average molecular weight by a factor of 2 to 20 occurs, in which one given (IV) reacts with more than one of the isocyanate groups thereof with more than one given (III); and

(d) reaction of the compound obtained in (c) with (meth)acrylate monomers (II).

In the present invention, the term “urethane” refers to the addition product of the group(s) of the poly(meth)acrylate (III) reactive to isocyanate groups and/or the (meth)acrylate (II) with the isocyanate groups of the isocyanate compound (IV). Depending on the type the group(s) reactive to isocyanate groups, units can for example be formed which comprise carbamic acid ester groups (—O—(CO)—NH—), carbonyloxycarbamoyl groups (—(CO)—O—(CO)—NH—), carbamide groups (—NH—(CO)—NH—) and/or thiocarbamic acid-S-ester groups (—S—(CO)—NH—).

In the polymeric addition product (V) obtained in step (c) of the poly(meth)acrylate (III) with groups reactive to isocyanate groups and isocyanate compound (IV) with more than one isocyanate group, (III) and (IV) are linked via urethane units formed in the addition reaction. Thus, the addition product (V) shows a polymeric backbone (derived from (III)) which is linked to groups with at least one free isocyanate group (derived from (IV) via urethane units. The addition product (V) can now on the one hand be linked with more poly(meth)acrylate (III) in step (c) via its free isocyanate groups, thus forming a partially cross-linked product, and on the other hand react with more (meth)acrylate (II) in step (d).

At the same time, the excess or unreacted isocyanate compound (IV) added in step (c) reacts with (meth)acrylate (II) to form urethane(meth)acrylate in step (d). The latter also assumes the role of a reactive diluent in the synthetic resin of the present invention.

An excess of the isocyanate compound (IV) is effectively used in step (c). This means that there is an excess of molecules of the isocyanate compound (IV), based on the total number of groups of compound (III) reactive to isocyanate groups present. Preferably, the isocyanate compound (IV) is added in step (c) in an amount of 2.5 to 20 mole equivalents per mole of the groups reactive to isocyanate groups.

The percentage of isocyanate groups of the isocyanate compound (IV) in step (c) that reacts with the groups reactive to isocyanate groups can for example be determined stoichiometrically, i.e. by selecting an excess of the isocyanate compound (IV) accordingly, based on the number of groups reactive to isocyanate groups present prior to the reaction of (III) and (IV) which, e.g., can be calculated based on the amounts of monomers (I) and (II) used in step (a).

Alternatively, the percentage of the isocyanate groups of the isocyanate compound (IV) which react with the groups reactive to isocyanate groups can be verified by determining the free isocyanate groups still present after the reaction of step (c) (e.g. by the titration method according to DIN 53185)

In a preferred embodiment, the present invention is directed to a synthetic resin wherein the reaction in step (b) and/or the reaction in step (c) is carried out in the presence of a solvent. It is especially preferred that the reaction in step (b) and the reaction in step (c) be carried out in the same solvent. According to the present invention, the solvent used can be removed after and/or during the reaction according to step (c). Meanwhile, the isocyanate compound (IV) added in step (c) can assume that function temporarily. In a special embodiment, a reactive diluent can be added before and/or after step (d) in order to adjust the viscosity.

Preferably, the (meth)acrylate monomers (I) and the (meth)acrylate monomers (II) are used in a molar ratio of 100:1 to 1:1, more preferred 20:1 to 4:1, in step (a). In a special embodiment, the isocyanate compound (IV) can be used in an amount of 2.5 to 20 mole equivalents, more preferred 4 to 12 mole equivalents, per mole of the groups reactive to isocyanate groups in step (c). It is preferred to use the (meth)acrylate monomers (II) in an amount of 1.0 to 1.1 mole equivalents per mole of the remaining isocyanate groups in step (d). Preferably, this way no free isocyanate groups should remain in the final product, the synthetic resin of the present invention.

The term (meth)acrylates as used in the present invention encompasses both methacrylates and acrylates.

According to the present invention, (meth)acrylates (I) which have no groups reactive to isocyanate groups are used in step (a). As (meth)acrylates (I) which have no groups reactive to isocyanate groups, (meth)acrylic acid esters are preferred in the present invention wherein the alcohol portion of the ester preferably comprises 1 to 18, more preferred 1 to 8, and most preferred 1 to 4, carbon atoms and can either be linear or branched. Optionally, the alcohol portion of the ester can comprise 1 to 8 heteroatoms such as oxygen, nitrogen or sulfur.

Examples of the above-mentioned (meth)acrylic acid esters include inter alia:

Methyl(meth)acrylate, ethyl(meth)acrylate, propyl(meth)acrylate, n-butyl(meth)acrylate, i-butyl(meth)acrylate, n-hexyl(meth)acrylate, 2-ethylhexyl(meth)acrylate, isodecyl(meth)acrylate, dodecyl(meth)acrylate, phenoxyethyl(meth)acrylate, cyclohexyl(meth)acrylate, isobornyl(meth)acrylate, benzyl(meth)acrylate, ethyleneglycolnonylphenylether(meth)acrylate, tripropyleneglycolnonylphenylether(meth)acrylate, tetrahydrofurfuryl(meth)acrylate, butyldiglycol(meth)acrylate, methoxpolyethyleneglycol(meth)acrylate, polyethyleneglycoldimethacrylate, ethyleneglycoldi(meth)acrylate, neopentylglycoldi(meth)acrylate, 1,3-butanedioldi(meth)acrylate, 1,4-butanedioldi(meth)acrylate, 1,6-hexanedioldi(meth)acrylate, 1,12-dodecanthioldi(meth)acrylate, stearyl(meth)acrylate, diethyleneglycoldi(meth)acrylate, triethyleneglycoltri(meth)acrylate, tetraethyleneglycoldimethacrylate, trimethylolpropanetri(meth)acrylate, dipentolhexa(meth)acrylate, di(meth)acrylate of the addition product of bisphenol A and ethylene oxide, diurethanedi(meth)acrylate and/or polyester(meth)acrylates.

Of these examples, methyl(meth)acrylate, ethyl(meth)acrylate, propyl(meth)acrylate, n-butyl(meth)acrylate and isobornyl(meth)acrylate are especially preferred.

Up to a maximum of 70% of the (meth)acrylate monomers (I) interpolymerized in poly(meth)acrylat (III) can be replaced with other monomers with reactive ethylenic groups. Compounds selected from vinyltoluene, vinyl acetate, styrene and (meth)acrylamides without groups reactive to isocyanate groups such as N-butoxymethyl(meth)acrylamide and 3-dimethylaminopropyl(meth)acrylamide can be used for this purpose.

As another component essential to the present invention, (meth)acrylate monomers (II) with (a) group(s) reactive to isocyanate groups are used in step (a). In order to guarantee a subsequent reaction with an isocyanate compound, the (meth)acrylates of the present invention comprise groups reactive to isocyanate groups. Basically, this includes (meth)acrylate monomers having at least one nucleophilic group which can enter into a chemical bond by reacting with isocyanate groups, such as e.g. a group selected from a hydroxyl, carboxy, amino and mercapto group, preferably a group selected from a hydroxyl, amino and mercapto group, more preferred a group selected from a hydroxy and an amino group and most preferred a hydroxyl group. The use of mixtures of (meth)acrylate monomers (II) carrying different ones of the above-mentioned groups is possible as well. Depending on the type or nucleophilic group of the group(s) reactive to isocyanate groups, units can be formed which for example comprise carbamic acid ester groups, carbonyloxycarbamoyl groups, carbamide groups and/or thiocarbamic acid-S-ester groups. In the present invention, they are summed up by the term “urethane” since the formed units derive from that structure. Units comprising carbamic acid ester groups, carbamide groups and/or thiocarbamic acid-S-ester groups are preferred, those comprising carbamic acid ester groups and/or carbamide groups are more preferred and those comprising carbamic acid ester groups are most preferred. Usually, one or more, preferably one, two, three or four, more preferred one, of the nucleophilic groups used according to the present invention is bonded to a C₂₋₁₀ hydrocarbon group, preferably a C₂₋₄ hydrocarbon group, which in turn is bonded to the acid group of the (meth)acrylate via an ester or amide bond (such as e.g. in methylol(meth)acrylamide), preferably an ester bond. Preferably, the nucleophilic group is one or more, preferably one, two, three or four, most preferred one, hydroxyl group(s). As an example for the use of two hydroxyl groups, reference is made to the dihydroxy-functional glycerinmono(meth)acrylate. The acrylic monomers with hydroxyl functionality which are preferably used in practical applications are hydroxy-C₂₋₁₀-alkyl-acrylates, in particular hydroxy-C₂₋₁₀-alkyl-acrylates, such as hydroxyethylacrylate (HEA) and hydroxypropylacrylate (HPA). The corresponding less toxic hydroxy-C₂₋₁₀-alkyl-methacrylates, in particular hydroxy-C₂₋₁₀-alkyl-methacrylates, such as 2-hydroxyethylmethacrylate and 2-hydroxypropylmethacrylate, can be used as well. Additional monoacrylates which can be used include e.g. diethyleneglycol-mono(meth)acrylate, polyethyleneglycol-mono(meth)acrylate, polypropyleneglycol-mono(meth)acrylate as well as the equimolecular reaction product of glycidyl(meth)acrylate and (meth)acrylic acid. According to the present invention, hydroxy-functional di(meth)acrylates, such as trimethyloldiacrylate (TMDA), trimethylolpropane-di(meth)acrylate or glycerin-di(meth)acrylate, and hydroxyl-functional triacrylates, such as pentaerithrol triacrylate (PETA), can be used. Corresponding binders exhibit especially high cross-linking densities in coatings and/or composites. The use of (meth)acrylic acid and (meth)acrylamide as monomers is less preferred in the present invention since they do not form very stable bonds with isocyanates.

In one embodiment of the present invention, the reaction in step (b) and/or in step (c) can be carried out in the presence of a solvent. In that case, the same solvent is preferably used in both reactions. Suitable solvents are characterized in that they do not comprise any nucleophilic groups such as e.g. hydroxyl or carboxylic acid groups and in that they have a suitable boiling point, preferably a boiling point of 40 to 150° C., more preferred a boiling point of 80 to 130° C., so that they can easily be removed after completion of and/or during the reaction. Preferred solvents which can be used in the present invention include esters, such as e.g. butylacetate, ketones, such as e.g. methyl ethyl ketone and methyl isobutyl ketone, ethers, such as e.g. tetrahydrofuran and dibutyl ether as well as aromatic hydrocarbons, such as e.g. toluene. Suitable solvents are known in the technical field and can easily be selected by the person skilled in the art depending on the reaction partners used in the reaction.

Preferably, the reaction according to step (b) is carried out by means of a free-radical solution polymerization of components (I) and (II). If a solvent is used in this reaction, the solvent can be removed after the reaction of step (b) has been completed or it can be replaced with a different solvent. In a preferred embodiment, the reaction mixture from step (b) is used directly in step (c) without a removal or a replacement of the solvent used.

In a special embodiment, the free-radical solution polymerization can be supported by the use of a catalyst. Free-radical chain initiators are preferred catalysts. Examples of suitable free-radical chain initiators known in the art include diacyl peroxides, such as benzoyl peroxide or dilauryl peroxide, alkyl hydroperoxides, such as t-butyl hydroperoxide or cumene hydroperoxide, alkyl peroxy esters, such as t-butyl perbenzoate and t-butylperoxy-2-ethylhexanoate, as well as azo compounds such as azodiisobutyronitrile. The catalyst, e.g. the free-radical chain initiator, is preferably used in an amount of 1 to 20 wt.-%, preferably 2 to 15 wt.-%, based on the total amount of components (I) and (II).

Mercaptans such as 1-dodecanthiol or alcohols such as 2-propanol can for example be used as polymerization regulators, preferably in an amount of 0 to 3 wt.-% each, based on the total amount of components (I) and (II). In order to control the molecule size, it is also possible to carry out a reaction under elevated pressure, preferably a pressure of more than atmospheric pressure (which is usually given as 1.01325 bar) to 8 bar, especially preferred 1.5 to 8 bar and most preferred 1.5 to 5 bar. Such pressure also allows, depending on the solvent used, work with elevated temperatures of up to about 250° C. if necessary (see below).

The polymerization in step (b) leads to poly(meth)acrylates (III) which have groups reactive to isocyanate groups.

The formation of the poly(meth)acrylates (III) according to the present invention usually takes place in the presence of suitable catalysts, e.g. free-radical chain initiators, by reacting the above-mentioned (meth)acrylates (II), with (a) group(s) reactive to isocyanate groups, and the above-mentioned (meth)acrylates (I), which have no groups reactive to isocyanate groups. Preferably, this reaction takes place in a suitable solvent. Preferred amounts of solvents are 10 to 150 wt.-%, in particular 50 to 100 wt.-%, based on components (I) and (II). It is expedient that the reaction take place at temperatures in the range of the boiling temperature of the solvent, i.e. under reflux. Preferred temperatures are in the range of 40 to 150° C., in particular 80 to 130° C. Under pressure, the reaction can also be carried out at temperatures of 40 to 250° C., in particular 100 to 180° C.

The poly(meth)acrylates (III) of the present invention preferably comprise 1 to 100, especially preferred 1 to 10, groups reactive to isocyanate groups and preferably consist of ten to one thousand (meth)acrylate monomer building stones of type I and II, preferably in a ratio of 100:1 to 1:1, more preferred in a ratio of 20:1 to 4:1. Preferred poly(meth)acrylates (III) have a weight-average molecular weight (M_{w}) of about 2,000 to 10,000 g/mole, preferably about 4,000 to 8,000 g/mole, most preferred about 6,000 g/mole (at a molecular weight distribution of about 400 to about 30,000 g/mole).

The poly(meth)acrylate (III) from step (b) is reacted in step (c) with an isocyanate compound (IV) which comprises more than one isocyanate group (polyisocyanate) in an addition reaction.

Of course, several different poly(meth)acrylates (III) can be used in step (c) as well.

On the one hand, aliphatic, aromatic and heterocyclic isocyanates with two or more isocyanate groups in a molecule (monomers) are used as polyisocyanates in the present invention.

Examples of polyisocyanates (IV) include:

Toluene-2,4-diisocyanate (2,4-TDI), toluene-2,6-diisocyanate (2,6-TDI), 3-phenyl-2-ethylene diisocyanate, 1,5-naphthalene diisocyanate, cumene-2,4-diisocyanate, 4-methoxy-1,3-diphenyl diisocyanate, 4-chloro-1,3-phenyl diisocyanate, diphenylmethane-4,4′-diisocyanate, diphenylmethane-2,4′-diisocyanate, diphenylmethane-2,2′-diisocyanate, 4-bromo-1,3-phenyl diisocyanate, 4-ethoxy-1,3-phenyl diisocyanate, 2,4′-diisocyanate-diphenylether, 5,6-dimethyl-1,3-phenyl diisocyanate, 2,4-dimethyl-1,3-phenyl diisocyanate, 4,4-diisocyanatodiphenylether, 4,6-dimethyl-1,3-phenyl diisocyanate, 9,10-anthracene diisocyanate, 2,4,6-toluene triisocyanate, 2,4,4′-triisocyanatodiphenylether, 1,4-tetramethylene diisocyanate, 1,6-hexamethylene diisocyanate (HDI), 1,10-decamethylene diisocyanate, 1,3-cyclohexylene diisocyanate, 4,4′-methylene-bis(cyclohexyl isocyanate), xylene diisocyanate, 1-isocyanato-3-methylisocyanato-3,5,5-trimethylcyclohexane (isophorone diisocyanate, IPDI), 1,3-bis(isocyanato-1-methylethyl)benzene (m-TMXDI) and 1,4-bis(isocyanato-1-methylethyl)benzene (p-TMXDI).

Furthermore, oligomers (so-called “prepolymers”) of the monomeric isocyanate compounds defined above can be used as well, preferably those of the above-mentioned examples of monomeric isocyanate compounds. The oligomers suitable for use in the present invention comprise two or more isocyanate groups. They preferably have a molecular weight of 100 to 1,500 g/mole. Examples of such oligomers are trimers of isocyanates as defined above (so-called “isocyanurates”) such as the trimer of hexamethylene triisocyanate (HDI) which has a molecular weight of 504.6 g/mole, and the trimer of isophorone diisocyanate (IPDI) which has a molecular weight of 666.9 g/mole. Both are trifunctional with respect to the isocyanate group.

Finally, reaction products of monomeric isocyanate compounds as defined above, preferably those of the above-mentioned examples of monomeric isocyanate compounds, can be used. The reaction products suitable for use in the present invention comprise two or more isocyanate groups. Examples of such reaction products are compounds obtained from the reaction of the monomeric isocyanate compounds defined above and polyols, such as e.g. ethyl glycol, propyl glycol, neopentyl glycol, hexane diol, trimethylolpropane, glycerin and hexane triol, or water. Examples thereof include polyisocyanate-polyol adducts such as the adduct of one molecule of trimethylol propane with three molecules of toluene diisocyanate (TDI), which is trifunctional with respect to the isocyanate group, and biureth compounds such as the reaction product of three molecules of hexamethylene triisocyanate (HDI) with one molecule of water, with the elimination of CO₂, which is bifunctional with respect to the isocyanate group.

The preferred use of aliphatic diisocyanates such as HDI or IDPI according to the present invention leads to especially lightfast synthetic resins which are resistant to discoloration.

Preferred reaction products of the reaction of poly(meth)acrylate (III) and isocyanat (IV) usually have a molecular weight distribution of about 1,000 to about 200,000 g/mole. The high molecular weight compared to the molecular weight prior to a reaction with the isocyanate compound (IV) indicates a partial cross-linking of the poly(meth)acrylate-urethane-(meth)acrylate according to the present invention. This can for example occur when a part of the molecules of the isocyanate compound (IV) which has more than one isocyanate group reacts with the groups reactive to isocyanate groups of more than one poly(meth)acrylate chain (III). This way, an increase in the weight average molecular weight by a factor of 2 to 20 occurs, i.e. a cross-linking of an average of 2 to 20 molecules of the poly(meth)acrylate (III).

In a preferred embodiment, the solvent used can be removed during and/or after completion of step (c).

The reaction mixture from step (c) is reacted with (meth)acrylate monomers (II) in step (d) wherein the groups reactive to isocyanate groups of the (meth)acrylate monomers (II) add to the remaining isocyanate groups in an addition reaction.

According to the present invention, the addition reactions in step (c) and/or (d) can be supported by the use of suitable catalysts. The usual urethanization catalysts such as e.g. triethylamine, DABCO or dibutyl tin dilaurate are optionally used as catalysts.

The adjustment to a suitable viscosity can be carried out before or after step (d) by the addition of (meth)acrylates and/or suitable reactive diluents.

Low-molecular compounds known in the prior art which preferably comprise 1 to 5 reactive double bonds can be used as reactive diluents. The following examples can be mentioned: Monofunctional reactive diluents (one, reactive double bond), such as isobornyl acrylate or N-vinyl pyrrolidone; difunctional reactive diluents (2 reactive double bonds), such as hexanediol diacrylate or tripropyleneglycol diacrylate, as well as tri- to hexafunctional reactive diluents (3 to 6 reactive double bonds) which cause an increase in the cross-linking density, such as trimethylolpropane tri(meth)acrylate, ethoxylated or propoxylated trimethylolpropane triacrylate, propoxylated glycerin triacrylate, pentaerythritol triacrylate, pentaerythritol tetraacrylate, ditrimethylolpropane tetraacrylate or dipentaerythritol hexaacrylate. Preferred amounts of reactive diluents are in the range of 0 to 50 wt.-%, in particular 0 to 30 wt.-%, based on the total composition.

The reactive diluents have two important functions. On the one hand, they reduce the viscosity of the radical hardenable composition, and on the other hand, they strongly influence the physical and chemical properties of the resulting composite material or workpiece, or paint.

A typical composition can for example comprise 52 wt.-% polymer, 25 wt.-% urethane(meth)acrylate and 23 wt.-% methyl(meth)acrylate and/or reactive diluent.

Here, it has to be noted that, depending on the molecular mass and the chemical structure of the various components contained in the synthetic resins of the present invention, the urethane group content therein, the ratio of the components and of course in the end also the temperature, the material is present in a liquid or wax-like pasty state. The fact that the material can be present in a wax-like pasty state even at room temperature depending on the circumstances described above is due to a large extent to the urethane groups contained therein; they are characterized by their high degree of polarity and their ability to form hydrogen bridge bonds.

Basically, mixtures of one or more poly(meth)acrylates (III) and other polyols such as e.g. trimethylolpropane, di(trimethylolpropane), pentaerythritol, di(pentaerythritol), neopentylglycol and methylpropanediol, as well as polyester polyols, polycarbonate diols or polyether polyols such as e.g. neopentylglycol propoxylate, trimethylolpropane ethoxylate, trimethylolpropane propoxylate, pentaerythritol ethoxylate and pentaerythritol propoxylate can be used in step (c) as well. When such polyols are used, the use of (meth)acrylate and reactive diluents for the adjustment of viscosity can possibly be foregone. However, the use of such polyols can adversely affect both mechanical and chemical properties, which is why such formulations are not considered preferred in the sense of the present invention.

The synthetic resin of the present invention prepared in step (d) is used as a radical hardenable composition either by itself or in combination with additives. The radical hardenable compositions according to the present invention are preferably prepared by mixing at least one of the synthetic resins based on poly(meth)acrylate-urethane-(meth)acrylates in urethane(meth)acrylates and optionally (meth)acrylates and/or reactive diluents as described above, and optionally one or more additives known to the person skilled in the art preferably selected from pigments (pigment pastes) such as e.g. white pigments such as titanium oxide, black pigments such as carbon blacks and iron oxide black, blue pigments such as copper phthalo cyanines, green pigments such as chromoxide green, yellow pigments such as iron oxide yellow, red pigments such as iron oxide red and other colored pigments; dyes such as e.g. aza[18]annulenes, nitro dyes, nitroso dyes, azo dyes, carbonyl dyes and sulfur dyes, fillers such as e.g. alkaline earth sulfates such as barite or blanc fixe, magnesium silicates such as talcum, aluminium silicates such as mica, organic and inorganic fibers such as glass fibers, microspheres made from siliceous material, aluminium hydroxide, aluminium oxide, chalk, micaceous iron ore and graphite, optionally coated with epoxy resin, polyurethane resin or water glass; and additives such as e.g. highly disperse silicic acid, bentonites (as anti-settling agents), stearic acid or waxes (as internal separating agents), wetting agents and anti-foaming agents; and multifunctional cross-linking agents such as e.g. trimethylol propane tri(meth)acrylate, ethoxylated or propoxylated trimethylol propane triacrylate, propoxylated glycerin triacrylate, pentaerythritol triacrylate, pentaerythritol tetraacrylate, ditrimethylol propane tetraacrylate or dipentaerythritol hexaacrylate. Preferred amounts of additives are 30 to 90 wt.-%, preferably 40 to 70 wt.-%, based on the total composition.

The radical hardenable compositions of the present invention preferably comprise catalysts promoting the free-radical polymerization, in particular free-radical chain initiators, especially preferred peroxides. They can for example be thermally activable or activable by incident light. Examples of suitable free-radical chain initiators, including examples of especially suitable peroxides, are listed above.

In order to preclude premature hardening of the inventive radical hardenable composition or the synthetic resin itself during production and storage, stabilizers or inhibitors can be added.

Examples of stabilizers or inhibitors suitable for preventing premature polymerization are listed below: 1,4-Dihydrobenzene (hydroquinone, HQ), 4-methoxyhydroxybenzene (hydroquinone monomethyl ether, HQME or MEHQ), 2,6-di-t-butylhydroquinone (DTBHQ), phenothiazine (thiodiphenylamine, PTZ), nitrobenzene.

They are preferably present in an amount of 50 to 1,000 ppm, based on the synthetic resin of the present invention. Nitrobenzene can optionally be added to suppress the also undesired gas-phase polymerization during production. The presence of oxygen during production is advantageous, however, it holds the danger of ignitable mixtures.

According to the present invention, composite materials and workpieces can be produced from the radical hardenable compositions described above. For this purpose, a radical hardenable composition according to the present invention is placed into a mold. This can be done more quickly with the compositions of the present invention—which due to the good wetting of the additives exhibit an excellent flow behavior—than with comparable mixtures of substances, for example those on the basis of MMA/PMMA.

After the mass has been fed into a mold, the mass in the mold is heated e.g with superheated steam preferably for 20 to 30 minutes at a pressure of preferably 3 to 4 bar to a temperature of preferably 70 to 130° C. After hardening, the composite material or the corresponding workpiece can be removed from the mold and processed further using known methods. Workpieces such as e.g. pot handles, switches for electrical devices, shell seats, wind turbine blades, decorative surfaces, garden tiles, benches, work surfaces and sinks can be produced from the radical hardenable compositions described above by means of free-radical polymerization while subjected to pressure, heat and forming.

In a preferred embodiment, the present invention is directed to a process for the production of workpieces from composite materials obtainable by hardening the radical hardenable composition of the present invention comprising the synthetic resin of the present invention, wherein the process comprises the following steps in addition to steps (a) to (d) described above:

(e) providing a composition comprising at least one mixture of the type obtained in step (d), which has optionally been diluted to a desired viscosity by the addition of (meth)acrylates and/or suitable reactive diluents and optionally one or more additives known to the person skilled in the art selected e.g. from pigments, dyes, fillers, additives, peroxides as catalysts and multifunctional cross-linking agents (suitable individual examples of the various types of additives are listed above);

(f) reacting the composition of step (e) at a high temperature and high pressure in a mold to obtain a composite material or workpiece, wherein the preferred temperature range is 40 to 150° C., in particular 70 to 130° C., and preferred pressure ranges are 0.5 to 5 bar, in particular 3 to 4 bar;

(g) optionally mechanically processing the composite material or workpiece obtained in step (f) to impart a final form.

The composite materials or workpieces of the present invention are characterized by a high degree of hardness and impact strength, gloss, depth of color, clarity, dimensional stability, hydrophobicity, oleophobicity, scratch resistance and a high degree of chemical resistance, thermal stability and UV-resistance, but also in that they are free of microcracks and bubbles.

The synthetic resins of the present invention can furthermore be used as components of a radical hardenable composition, also for the production of paints. In that case, the desired viscosity of the composition can optionally be adjusted with at least one (meth)acrylate and/or reactive diluent, preferably with a reactive diluent. Examples of suitable reactive diluents are listed above. This way, the use of conventional solvents and other volatile components which could be trapped in the paint after hardening can essentially be prevented. The advantages resulting therefrom have already been discussed. For the production of the paint, a radical hardenable composition of the present invention is subjected to hardening, preferably through the exposure to UV light. Advantageously, a radical hardenable composition intended for hardening through exposure to UV light additionally comprises a photoinitiator, such as e.g. a catalyst activable by light and promoting free-radical polymerization, in particular a free-radical chain initiator that can be activated in that manner. The paint according to the present invention comprises the composition in hardened form.

To sum up, it can be stated that the poly(meth)acrylate-urethane-(meth)acrylates of the present invention are, on the one hand, characterized in particular by their production method which in a preferred embodiment allows stripping the solution of the reaction product of poly(meth)acrylate (III) with an isocyanate compound (IV) in the presence of the isocyanate compound, and thus allows access to the synthetic resins of the present invention which, despite a high molecular weight, such as preferably a molecular weight of 1,000 to 200,000 g/mole, of the poly(meth)acrylate-urethane-(meth)acrylates contained therein—if needed—only comprise reactive solvents. On the other hand, they are characterized by their multifunctionality which entails a high degree of cross-linking in the hardened state, as well as by the urethane groups they contain which due to their polar nature largely optimize the range of properties of the poly(meth)acrylate-urethane-(meth)acrylates of the present invention and thus of the composite materials, composite workpieces and paints producible therefrom.

The present invention is described in more detail in the following examples; however, they are not intended to restrict the invention in any way. The information given in wt.-% refer to the mixture as it is present at that time.

### EXAMPLES

### Example A

### Preparation of a Synthetic Resin on the Basis of poly(meth)acrylate-urethane-(meth)acrylates in urethane(meth)acrylates

A polymethylmethacrylate solution with a viscosity of about 0.3 Pa·s and a solids content of at least 47.5 wt.-% is prepared under reflux from 24.79 kg methylmethacrylate, 1.70 kg 2-hydroxyethylmethacrylate and 3.26 kg t-butylperoxybenzoate in a total of 30.96 kg butyl acetate in a manner known to the person skilled in the art of polymerization reactions. The viscosity is measured with the Höppler viscosimeter according to DIN 53015, the solids content is determined with the Sartorius Moisture Analyzer MA 30 for 15 min at 100° C. on the basis of a 2 g sample.

At 80° C. and under nitrogen, 5.48 kg hexamethylene diisocyanat (HDI) are then added. Then distillation is carried out under nitrogen until a temperature of 180° C. is reached. If there is still an excess of butyl acetate, the nitrogen supply is discontinued and the remaining butyl acetate is removed in a vacuum. After the distillation has been completed, the vacuum is broken with nitrogen and cooled to 120° C., 2.90 kg isophorone diisocyanate (IPDI) are added to reduce viscosity, then the mixture is cooled further to 80° C.; when 80° C. has been reached, 0.04 kg hydroquinone monomethylether in 16.11 kg methyl methacrylate are added for stabilization and dilution.

After complete mixing, 0.002 kg dibutyl tin dilaureate in 10.17 kg 2-hydroxyethyl methacrylate (2-HEMA) are added. It is held at 80° C. until an isocyanate content of less than 0.3 wt.-% is reached, with the content being determined according to DIN 53185. Then the mixture is cooled, filtered through a sparkler filter and decanted.

A solution of a poly(meth)acrylate-urethane-(meth)acrylate of the following composition is obtained:

about 52 wt.-% poly(meth)acrylate-urethane-(meth)acrylate,

about 25 wt.-% monomeric methyl methacrylate (MMA),

about 23 wt.-% urethane(meth)acrylate.

This solution is characterized by the following parameters:

Höppler viscosity according to DIN 53015: about 7.0 Pa·s,

solids content in a Sartorius Moisture Analyzer MA 30 (2 g sample, 15 min, 100° C.): about 75 wt.-%,

color index according to ISO 4630:0 to 1.

After dilution with another 4.60 kg methyl methacrylate to an MMA content of 30 wt.-% a solution of the following composition is obtained:

about 50 wt.-% poly(meth)acrylate-urethane-(meth)acrylate,

about 30 wt.-% monomeric methyl methacrylate (MMA),

about 20 wt.-% urethane(meth)acrylate.

This solution is characterized by the following parameters:

Höppler viscosity according to DIN 53015: about 2.5 Pa·s,

solids content in a Sartorius Moisture Analyzer MA 30 (2 g sample, 15 min, 100° C.): about 70 wt.-%,

color index according to ISO 4630:0 to 1.

### Example B

### Preparation of a Radical Hardenable Composition

6.03 kg of the solution of A comprising 25 wt.-% methyl methacrylate, 2.44 kg methyl methacrylate, 16.60 kg quartzy filler, 0.5 kg pigment paste, 0.08 kg peroxan PO are mixed. At 20° C. a viscosity of about 0.38 Pa·s is measured on a Brookfield viscosimeter.

### Example C

### Production of a Workpiece

The radical hardenable composition of B is fed into a mold for a workpiece within 70 seconds.

After heating the mass in the mold with superheated steam to 120° C. over 25 min at a pressure of 3.3 bar, a workpiece is obtained which stands out positively against the status quo, wherein a mixture of substances with 20 to 40 wt.-% of a solution of PMMA in MMA is used, in particular with respect to the following properties:
higher gloss
higher brilliance
increased depth of color
markedly reduced shrinkage during hardening, e.g. in a mold
highly reduced number of pores
highly reduced pore size
calmer surface
no cracks

Furthermore, the composite material exhibits good mechanical properties such as a high degree of chemical resistance and thermal stability. For instance, no cracking or optical brightening is observed in an alternating hot-cold water test after 500 cycles. Moreover, the composition used in the production of these optimized materials and workpieces is characterized by improved flow behavior and thus also in that the filler contained therein a wetted more uniformly.

Thus, the materials of the present invention fulfill all the requirements compared to the known materials such as no or fewer and smaller bubbles and cracks, improved chemical resistance and thermal stability, no or less shrinkage and emissions during their production, shorter production times and improved optical properties; while maintaining the positive properties such as impact strength, UV-resistance, and hydrophobicity and oleophobicity.

1. Synthetic resin, based on poly(meth)acrylate-urethane-(meth)acrylates in urethane(meth)acrylates, obtainable by:
(a) provision of (meth)acrylate monomers (I), which have no groups reactive to isocyanate groups and (meth)acrylate monomers (II), with (a) group(s) reactive to isocyanate groups,
(b) polymerization of the (meth)acrylate monomers (I) and (II) to give a poly(meth)acrylate (III), with groups reactive to isocyanate groups,
(c) reaction of the poly(meth)acrylate (III) with an isocyanate compound (IV), with more than one isocyanate group, in such a manner that 5 to 40% of the isocyanate groups of the isocyanate compound (IV) react with the above groups reactive to isocyanate groups, whereby partial cross-linking of (III) with an increase in weight average molecular weight by a factor of 2 to 20 occurs, in which one given (IV) reacts with more than one of the isocyanate groups thereof with more than one given (III); and
(d) reaction of the compound obtained in (c) with (meth)acrylate monomers (II).

2. Synthetic resin according to claim 1, wherein the reaction in step (b) and/or the reaction in step (c) takes place in the presence of a solvent.

3. Synthetic resin according to claim 2, wherein the reaction in step (b) and the reaction in step (c) are carried out in the same solvent.

4. Synthetic resin according to claim 3, wherein the solvent is removed after and/or during the reaction according to step (c).

5. Synthetic resin according to claim 1, wherein in addition a (meth)acrylate and/or a reactive diluent is/are added before and/or after step (d).

6. Synthetic resin according to claim 1, wherein in step (a) the (meth)acrylate monomers (I) and the (meth)acrylate monomers (II) are used in a molar ratio of 100:1 to 1:1.

7. Synthetic resin according to claim 1, wherein in step (c) the isocyanate compound (IV) is used in an amount of 2.5 to 20 mole equivalents per mole of the groups reactive to isocyanate groups.

8. Synthetic resin according to claim 1, wherein in step (d) the (meth)acrylate monomers (II) are used in an amount of 1.0 to 1.1 mole equivalents per mole of the remaining isocyanate groups.

9. Process for producing a radical-hardenable composition, comprising:
a) providing a synthetic resin of claim 1; and
b) formulating the synthetic resin with additives to form a radical-hardenable mass.

10. (canceled)

11. Radical-hardenable composition comprising a synthetic resin according to claim 1.

12. Radical-hardenable composition according to claim 11, additionally comprising at least one additive selected from pigments, dyes, fillers and auxiliary agents.

13. Radical-hardenable composition according to claim 11, additionally comprising a multi-functional cross-linking agent.

14. (canceled)

15. Composite material or composite workpiece comprising a radical-hardenable composition according to claim 11 in hardened form.

16. Process for the production of a composite material or composite workpiece according to claim 15, wherein the radical-hardenable composition is subjected to hardening.

17. Process for the production of a composite material or composite workpiece according to claim 16, wherein hardening is caused by pressure, heat and forming.

18. Paint comprising a radical-hardenable composition according to claim 11.

19. Paint according to claim 18, wherein the paint is hardened.

20. Process for the production of a hardened paint according to claim 19, wherein the radical-hardenable composition is subjected to hardening.

21. Process for the production of paint according to claim 20, wherein hardening is caused by UV light.
